(19) United States
(12) Patent Application Publication
(10) Pub. No.: US 2003/0174320 A1
(43) Pub. Date: Sep. 18, 2003

(54) Piercing inspection apparatus

(76) Inventors: Yoshio Yokoyama, Anjyo-city (JP); Takao Minami, Kuwana-city (JP); Tamaaki Sibuya, Kuwana-city (JP); Kenji Yoneda, Kyoto-city (JP)

Correspondence Address: NIXON & VANDERHYE, PC, 1100 N GLEBE ROAD, 8TH FLOOR, ARLINGTON, VA, 22201-4714, US

(21) Appl. No.: 10/379,549

(22) Filed: Mar. 6, 2003

(30) Foreign Application Priority Data
Mar. 12, 2002 (JP) 2002-066781

(51) Int. Cl. G01N 21/00

(52) U.S. Cl. 356/237.6

(57) ABSTRACT

A piercing inspection apparatus allows inspection of piercing of through-holes of a honeycomb structure having a number of parallel through-holes which extend therethrough from a first open end to a second open end of the honeycomb structure. The apparatus includes a lighting device which emits light onto the first open end of the honeycomb structure, so that the light passes through the through-holes, a telecentric optical system which converges the light emitted from the through-holes at the second open end to form inspection images corresponding to the through-holes, a camera which picks up the inspection images, and a monitor in which the picked up inspection images are indicated.

### BACKGROUND OF THE INVENTION

1. Field of the Invention

The present invention relates to a piercing inspection apparatus for inspecting piercing of a honeycomb structure having parallel through-holes formed therein.

2. Description of the Related Art

Conventionally, piercing of a number of parallel through-holes formed in a honeycomb structure is inspected visually by an operator or by a camera (e.g., see Japanese Unexamined Patent Publication No. 6-258183). Namely, as shown in FIG. 8, light 2 is irradiated onto a first open end 911 of a honeycomb structure 91 from a lighting device 92. The light 2 passing through a number of through-holes 913 of the honeycomb structure is emitted from a second open end 912 opposite the first open end 911. The light 2 emitted from the second open end 912 is viewed by an operator or a camera. If a sufficient amount of light 2 is seen by the operator or received by the camera, it is judged that the through-holes are completely pierced. Conversely, if an insufficient amount of light 2 is received, it is judged that the through-holes 913 are not pierced completely and are defective.

However, in recent years, in which an improvement of the exhaust gas purifying efficiency of a motor car has been required, it is necessary to make a fine honeycomb structure 91, which is a carrier of a catalytic converter, in order to increase the surface area of the catalytic converter. The fine honeycomb structure 91 makes it difficult to effectively inspect the piercing of the through-holes 913.

Namely, in the piercing inspection, the rays of light which pass through the through-holes 913 are substantially only those parallel with the axes of the through-holes. Therefore, in the piercing inspection of the prior art, the operator's eyes are in parallel with the rays of light 2 passing through the through-holes 913 only in a limited area, because the human eye or camera has a certain extent of an angle of field of view. Therefore, it is necessary to move the position of the eye E in order to carry out the piercing inspection of the through-holes 913, as shown in FIG. 8. It is necessary to move the eye position more frequently as the honeycomb structure 91 is made finer, that is, the diameter of the through-holes 913 is made smaller.

Under these circumstances, it is difficult to effectively inspect the piercing of the through-holes 913 of the honeycomb structure 91.

### SUMMARY OF THE INVENTION

The present invention is aimed at eliminating the drawbacks of the prior art by providing a piercing inspection apparatus in which the piercing of through-holes of a honeycomb structure can be effectively carried out.

According to a first embodiment of the invention, there is provided a piercing inspection apparatus to inspect piercing of through-holes of a honeycomb structure having a number of parallel through-holes which extend therethrough from a first open end to a second open end of the honeycomb structure, comprising a lighting device which emits light onto the first open end of the honeycomb structure, so that the light passes through the through-holes, a telecentric optical system which converges the light emitted from the through-holes at the second open end to form inspection images corresponding to the through-holes, a camera which picks up the inspection images, and a monitor in which the picked up inspection images are indicated.

The mode of operation and the effects of the invention will be discussed below.

The piercing inspection apparatus has a telecentric optical system. Light emitted from the through-holes which open into the second open end is condensed using the telecentric optical system. Consequently, the rays of light passing through a number of through-holes of the honeycomb structure can be substantially uniformly gathered. Namely, the rays of light passing through the through-holes are substantially parallel with each other and with the axes of the through-holes. Therefore, if the optical axis of the telecentric optical system extends in the direction of the axes of the through-holes, it is possible to condense the substantially parallel rays of light passing through the through-holes.

Inspection images corresponding to the through-holes are formed by the condensed light rays and are picked-up by the camera. The inspection images corresponding to the through-holes, picked up by the camera are indicated in the monitor or are analyzed by an image processor. Consequently, the piercing of the plural through-holes can be inspected at one time.

Therefore, it is possible to effectively carry out the piercing inspection of the through-holes of the honeycomb structure.

As may be understood from the foregoing, according to the present invention, a piercing inspection apparatus in which the piercing inspection of through-holes of a honeycomb structure can be effectively performed can be provided.

According to a second embodiment of the invention, there is provided a piercing inspection apparatus to inspect piercing of through-holes of a honeycomb structure having a number of parallel through-holes which extend therethrough from a first open end to a second open end of the honeycomb structure, comprising a lighting device which emits light onto the first open end of the honeycomb structure, so that the light passes through the through-holes, an optical system which converges the light emitted from the through-holes at the second open end to form inspection images corresponding to the through-holes, a camera which picks up the inspection images, and a monitor in which the picked-up inspection images are indicated, said optical system being provided with a Fresnel convex lens and a wide-angle lens, said Fresnel convex lens and said wide-angle lens being arranged with the optical axis and the focal point of the Fresnel convex lens being identical to those of the wide-angle lens.

With this arrangement, the substantially parallel rays of light passing through the through-holes are refracted toward the wide-angle lens by the Fresnel convex lens and are converged onto the image pickup surface of the camera by the wide-angle lens to form the inspection images.

Consequently, the same effects as those obtained by the use of the telecentric optical system can be obtained by the use of the optical system in the second embodiment of the invention.

In addition to the foregoing, an inexpensive piercing inspection apparatus can be provided because an optical system similar to the telecentric optical system can be realized using the Fresnel convex lens and the wide-angle lens.

As may be seen from the above discussion, according to the present invention, it is possible to provide a piercing inspection apparatus in which the piercing inspection of the through-holes of the honeycomb structure can be effectively carried out.

In the first embodiment, the sectional shape of the through-holes can be, for example, a square of 0.6×0.6 mm to 1.2×1.2 mm. The length of the through-holes, i.e., the distance from the first open end to the second open end is, for example, in the range of 50 to 170 mm. The maximum diameter of the honeycomb structure in a section perpendicular to the direction of the length of the through-holes is, for example, in the range of 70 to 170 mm.

A CCD camera, a CMOS camera, or a line sensor, etc., can be used as the camera.

The lighting device is preferably a surface light source which emits parallel rays of light. With the surface light source, clearer inspection images can be obtained.

Alternatively, the lighting device can be a surface light source which emits scattered light. In this alternative, it is preferable that the distance between the lighting device and the first open end of the honeycomb structure be in the range of 20 to 1000 mm.

In the first embodiment, it is preferable that the telecentric optical system be constructed to converge the rays of light emitted from all the through-holes of the honeycomb structure, so that the inspection images are formed corresponding to all the through-holes. With this arrangement, it is possible to carry out the piercing inspection of the through-holes of the honeycomb structure at one time. Therefore, the piercing inspection of the through-holes of the honeycomb structure can be more effectively performed.

In the first and second embodiment, the honeycomb structure may be made of a ceramic or a metal. With this structure, a piercing inspection apparatus, in which the piercing inspection of through-holes of a honeycomb structure can be effectively carried out, can be provided.

In the first embodiment, it is preferable that the piercing inspection apparatus be provided with an axis alignment device for aligning the optical axis of the telecentric optical system with the direction of the axes of the through-holes. The optical axis of the telecentric optical system can be easily and correctly aligned with the direction of the axes of the through-holes by the axis alignment device. Therefore, if the diameter of the through-holes is small, the piercing of the through-holes can be correctly and effectively inspected.

In the second embodiment, it is preferable that the piercing inspection apparatus be constructed so that the rays of light emitted from the through-holes of the honeycomb structure are condensed and that the inspection images are formed corresponding to the through-holes.

With this arrangement, all the through-holes of the honeycomb structure can be subjected to a piercing inspection at once. Therefore, the piercing inspection of the through-holes of the honeycomb structure can be more effectively carried out.

Furthermore, the piercing inspection apparatus is preferably provided with an axis alignment device for aligning the optical axis of the optical system with the direction of the axes of the through-holes of the honeycomb structure. The optical axis of the optical system can be easily and correctly aligned with the direction of the axes of the through-holes by the axis alignment device. Therefore, even if the diameter of the through-holes is small, the piercing of the through-holes can be correctly and effectively inspected.

The present invention may be more fully understood from the description of preferred embodiments of the invention set forth below, together with the accompanying drawings.

### BRIEF DESCRIPTION OF THE DRAWINGS

In the drawings;

FIG. 1 is an explanatory view of a piercing inspection apparatus according to a first embodiment of the invention;

FIG. 2 is a perspective view of a honeycomb structure;

FIG. 3 is a sectional view of a honeycomb structure in the direction of axes of through-holes, in a first embodiment of the invention;

FIG. 4 is an explanatory view of a telecentric optical system in a first embodiment of the invention;

FIG. 5 is an explanatory view of inspection images in a first embodiment of the invention;

FIG. 6 is an explanatory view of a piercing inspection apparatus according to a second embodiment of the invention;

FIG. 7 is an explanatory view of an optical system in a second embodiment of the invention; and

FIG. 8 is an explanatory view of a piercing inspection method in the prior art.

### DESCRIPTION OF PREFERRED EMBODIMENTS

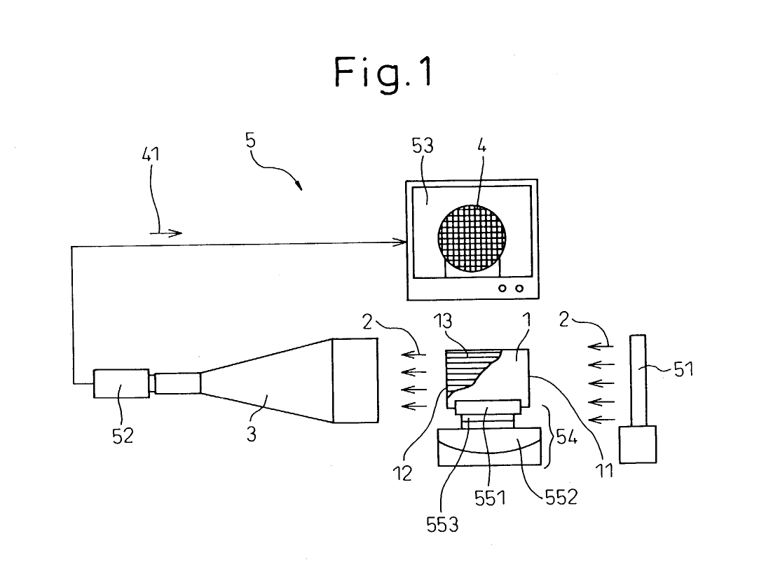

A first embodiment of a piercing inspection apparatus according to the present invention will be discussed below with reference to FIGS. 1 through 5.

The piercing inspection apparatus 5 is used to carry out a piercing inspection method for inspecting piercing of through-holes 13 of a honeycomb structure 1 having a number of through-holes 13, as shown in FIGS. 1 through 3. As can be seen in FIG. 3, the through-holes 13 extend in parallel with each other from a first open end 11 to a second open end 12 of the honeycomb structure 1.

As shown in FIG. 1, light 2 is irradiated onto the first open end 11 of the honeycomb structure 1 and passes through the through-holes 13. The rays of light emitted from the through-holes 13 which open at the second open end 12 are condensed by a telecentric optical system 3 to form inspection images 4 corresponding to the through-holes 13. The inspection images 4 are picked up by a camera 52.

The piercing of the through-holes 13 of the honeycomb structure 1 is inspected using the inspection images 4 picked up by the camera 52.

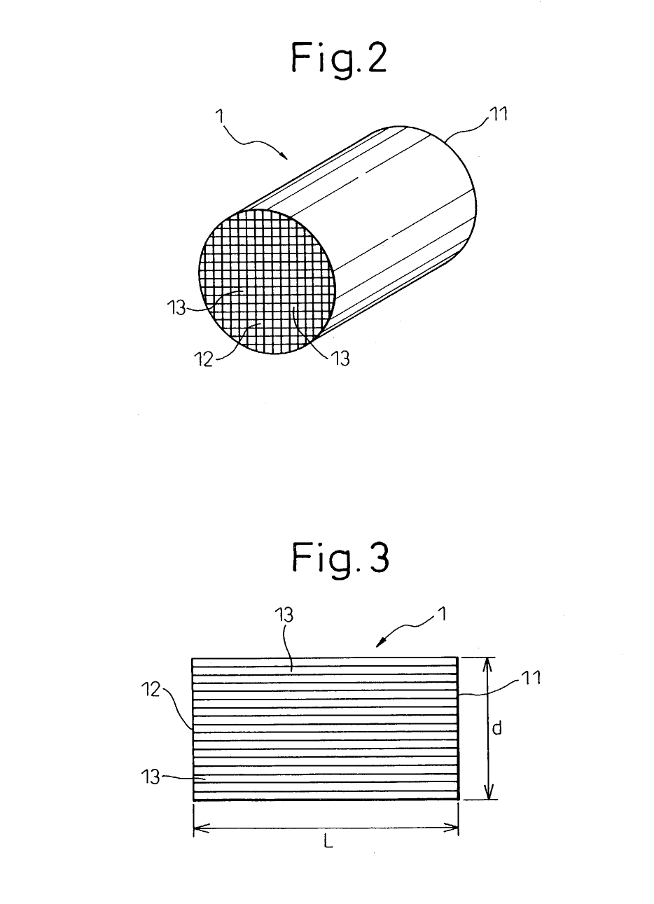

The through-holes 13 have a square cross section of approximately 1.1 mm×1.1 mm, as shown in FIG. 2. Also, as shown in FIG. 3, the length L of the through-holes 13, i.e., the distance from the first open end 11 and the second open end 12 is approximately 150 mm. The maximum diameter d of the honeycomb structure 1 in a section perpendicular to the direction of the axes of the through-holes 13 is approximately 100 mm.

In the illustrated embodiment, the honeycomb structure 1 is made of a ceramic. Note that the present invention is not limited thereto and can be applied to a honeycomb structure made of a metal.

The telecentric optical system 3 constitutes an optical system in which an aperture stop 32 is located at a focal point F of a lens 31 so that the principle ray 21 passes through the focal point F. The principal ray 21 refers to a ray which is emitted from an object point P and passes through the center of the aperture stop 32.

Therefore, using the telecentric optical system 3, the light 2 parallel with the optical axis K of the telecentric optical system 3 can be the principle ray 21 even if the light 2 is deviated from the optical axis K. Therefore, light 2 parallel with the optical axis K, emitted from the through-holes 13 of the honeycomb structure 1 can be converged as the principle rays 21, onto the image pickup surface 521 of the camera 52, even if the light is deviated from the optical axis K.

Therefore, the inspection images 4 corresponding to a number of through-holes 13 can be obtained over a wide area.

The piercing inspection apparatus 5 used for the piercing inspection method is comprised of a lighting device 62 which emits the light 2 onto the first open end 11, so that the light passes through the through-holes 13, the telecentric optical system 3, the camera 52, and a monitor 53 in which the inspection images 4 are indicated.

In this embodiment, the telecentric optical system 3 is made of a commercially available telecentric lens and the camera 52 is a CCD camera. Note that a CMOS camera or a line sensor, etc., can be used for the camera 52.

As shown in FIG. 1, the telecentric optical system 3 is constructed so that the rays of light emitted from all of the through-holes 13 of the honeycomb structure 1 can be condensed. The inspection images 4 are formed corresponding to all the through-holes 13 of the honeycomb structure 1.

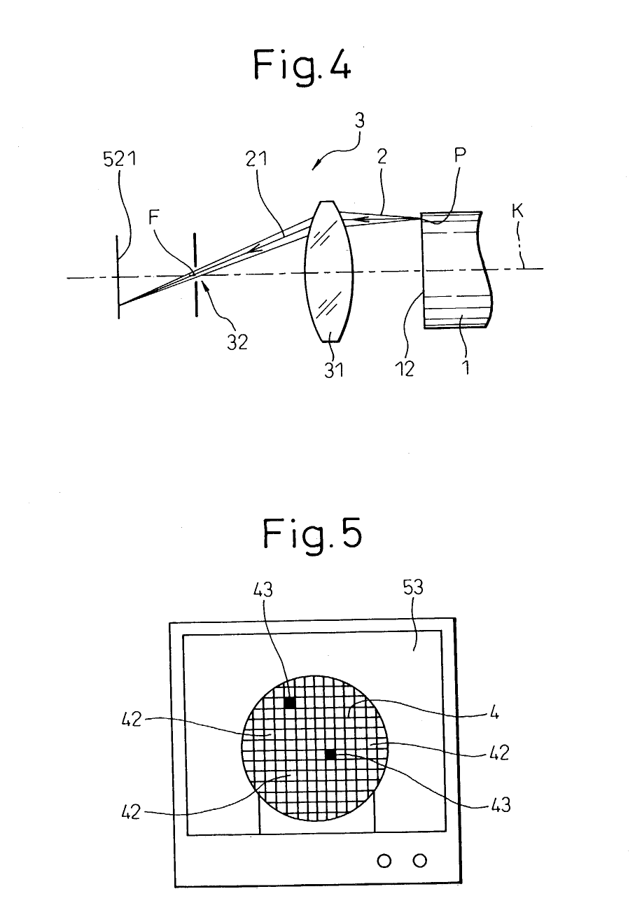

The piercing inspection apparatus 5 has an axis alignment device 54 which aligns the optical axis K (FIG. 4) of the telecentric optical system 3 with the direction of the axes of the through-holes 13 of the honeycomb structure 1.

Namely, the piercing inspection apparatus 5 has a holder 55 which holds the honeycomb structure 1 to be inspected. The holder 55 is provided with a holding portion 551 which holds the honeycomb structure 1, an inclination adjusting mechanism 552 which can rotate the holding portion 551 in a vertical plane, and a rotation adjusting mechanism 553 which can rotate the holding portion 551 in a substantially horizontal plane. The inclination adjusting mechanism 552 and the rotation adjusting mechanism 553 constitute the axis alignment device 54.

The piercing inspection method using the piercing inspection apparatus 5 will be discussed below.

The components of the piercing inspection apparatus 5 are arranged as shown in FIG. 1 and the honeycomb structure 1 is held on the holder 55. The distance between the lighting device 51 and the first open end 11 of the honeycomb structure 1 is set to be in the range of approximately 20 to 1000 mm.

Thereafter, the light is impinged upon the entire surface of the first open end 11 of the honeycomb structure 1 from the lighting device 51. After that, the optical axis K of the telecentric optical system 3 is made coincident with the direction of the axes of the through-holes 13 of the honeycomb structure 1 by the axis alignment device 54. As a result, the light 2 emitted from the lighting device 51 can enter all the through-holes 13 of the honeycomb structure 1. The light 2 emitted from the through-holes 13 at the second open end 12 of the honeycomb structure 1 is received by the telecentric optical system 3. The light 2 received by the telecentric optical system 3 is converged onto the image pickup surface 521 of the camera 52 and forms the inspection images 4 (FIG. 4).

The inspection images 4 are picked up by the camera 52. The image signals 41 of the picked inspection images are transmitted to the monitor 53. The inspection images 4 are indicated in the monitor 53, as shown in FIG. 5.

The inspection images 4 indicated in the monitor 53 are visually confirmed by an operator. Consequently, it can be found that the through-holes 13 corresponding to light image portions 42 (white image portions) on the monitor screen are linearly pierced. Also, it can be found that the through-holes 13 corresponding to dark image portions (black image portions) 43 of the inspection images 4 on the monitor screen 53 do not extend linearly.

The mode of operation and effects of the invention will be discussed below.

In the piercing inspection method mentioned above, the light 2 emitted from the through-holes 13 at the second open end 12 of the honeycomb structure 1 is condensed by the telecentric optical system 3. Therefore, the rays of light 2 passing through a large number of through-holes 13 of the honeycomb structure 1 can be substantially uniformly converged.

Namely, the light 2 passing through the through-holes 13 is substantially parallel with the through-holes 13 and substantially parallel with each other. Therefore, if the optical axis K of the telecentric optical system 3 is aligned with the direction of the axes of the through-holes 13, the substantially parallel rays of light 2 passing through a large number of through-holes 13 can be substantially uniformly converged.

The inspection images 4 corresponding to the through-holes 13 are formed by the converged rays of light 2 and are picked up by the camera 52. Thus, the piercing of the through-holes 13 can be inspected at one time, based on the inspection images 4 picked up by the camera 52.

Namely, the piercing of the through-holes 13 can be inspected at once, by indicating the inspection images 4 corresponding to the through-holes 13, picked up by the camera 52 in the monitor 53. Therefore, the piercing of a large number of through-holes 13 of the honeycomb structure 1 can be effectively inspected.

The telecentric optical system 3 is constructed so that the rays of light 2 emitted from all the through-holes 13 of the honeycomb structure are converged, so that the inspection images 4 are formed corresponding to all of the through-holes 13 of the honeycomb structure 1 (FIG. 5). Consequently, it is possible to inspect the piercing of all the through-holes 13 of the honeycomb structure 1 at one time. Therefore, the piercing inspection of the through-holes of the honeycomb structure 1 can be more effectively carried out.

The piercing inspection apparatus 5 is provided with the axis alignment device 54 which aligns the optical axis K of the telecentric optical system 3 with the direction of the axes of the through-holes 13 of the honeycomb structure 1. With the axis alignment device 54, the optical axis K of the telecentric optical system 3 can be easily and correctly aligned with the direction of the axes of the through-holes 13. As a result, the piercing inspection of the through-holes 13 can be correctly carried out even if the diameter of the through-holes is small, and the piercing efficiency can be enhanced.

As may be understood from the above discussion, according to the present invention, a piercing inspection apparatus in which the piercing inspection of through-holes of a honeycomb structure can be effectively carried out can be provided.

Although the images on the monitor screen are checked by an operator in the first embodiment, it is alternatively possible to use an image processor instead thereof, to check whether or not the through-holes are linearly and completely pierced.

Namely, in this alternative, the piercing of the through-holes is represented by the brightness of the inspection images formed by the telecentric optical system. Therefore, the piercing of the through-holes can be easily inspected, based on the brightness of the inspection images obtained by the image processing operation.

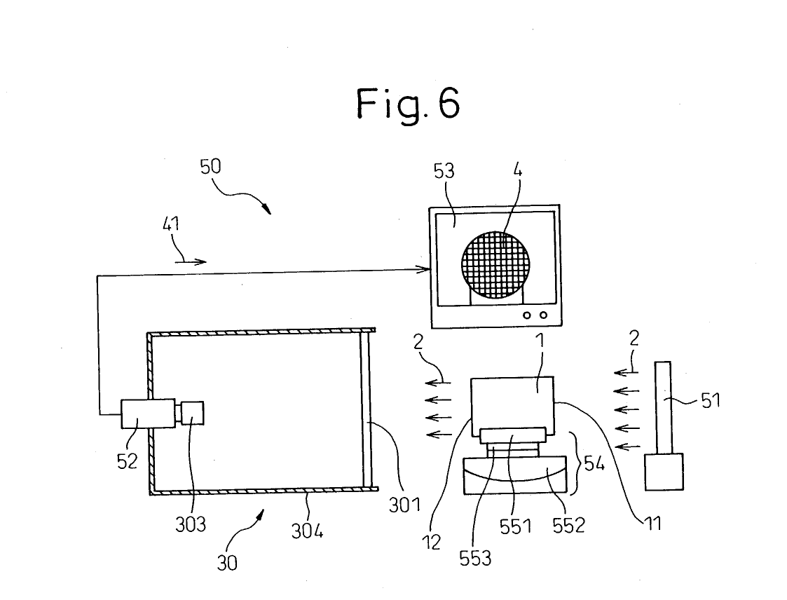

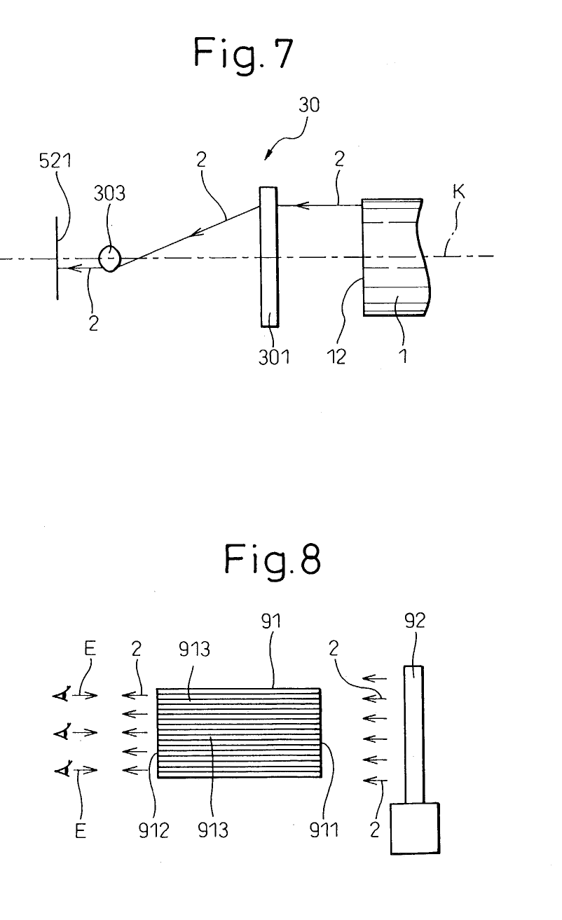

A second embodiment of the piercing inspection apparatus according to the present invention will be explained below, with reference to FIGS. 6 and 7.

In a piercing inspection apparatus 50 in this embodiment, an optical system 30 which has the same effects as the telecentric optical system 3 in the first embodiment is comprised of a Fresnel convex lens 301, a wide-angle lens 303, and a light interception plate 304, as shown in FIGS. 6 and 7. The Fresnel convex lens 301 and the wide-angle lens 303 are arranged so that the optical axes K thereof are aligned and that wide-angle lens 303 is located at the focal point of the Fresnel convex lens 301. Strictly speaking, the Fresnel convex lens 301 and the wide-angle lens 303 are arranged with the focal point of the Fresnel convex lens being substantially identical to the focal point of the wide-angle lens.

The wide-angle lens 303 is mounted to the camera 52.

The focal length of the Fresnel convex lens 301 is, for example, in the range of 150 to 400 mm, and the focal length of the wide-angle lens 303 is, for example, in the range of 6 to 25 mm.

Moreover, the diameter of the Fresnel convex lens 301 is greater than the diameter of the honeycomb structure 1 and is, for example, 300 mm. The diameter of the wide-angle lens 303 is approximately 40 mm.

Furthermore, the light interception plate 304 intercepts external light so as to prevent light other than the light 2 passing through the Fresnel convex lens 301 from reaching the wide-angle lens 303. The rest of the structure is the same as that in the first embodiment.

In the second embodiment, the substantially parallel rays of light passing through the through-holes 13 of the honeycomb structure 1 are refracted toward the wide-angle lens 303 by the Fresnel convex lens 301 and are converged onto the image pickup surface 521 of the camera 52 to form the inspection images 4.

The same effects as the telecentric optical system (telecentric lens) 3 in the first embodiment can be expected from the optical system 30 in the second embodiment.

Moreover, in the second embodiment, the optical system 30 is comprised of the Fresnel convex lens 301, the wide-angle lens 303 and the light interception plate 304, as mentioned above, and hence the optical system 30 can be inexpensively obtained, thus resulting in realization of an inexpensive piercing inspection apparatus 50.

The mode of operation and effects the same as those in the first embodiment can be obtained in the second embodiment.

While the invention has been described by reference to specific embodiments chosen for purposes of illustration, it should be apparent that numerous modifications could be made thereto by those skilled in the art without departing from the basic concept and scope of the invention.

What is claimed is:

1. A piercing inspection apparatus to inspect piercing of through-holes of a honeycomb structure having a number of parallel through-holes which extend therethrough from a first open end to a second open end of the honeycomb structure, comprising;
a lighting device which emits light onto the first open end of the honeycomb structure, so that the light passes through the through-holes;
a telecentric optical system which converges the light emitted from the through-holes at the second open end to form inspection images corresponding to the through-holes;
a camera which picks up the inspection images; and,
a monitor in which the picked up inspection images are indicated.

2. A piercing inspection apparatus according to claim 1, wherein said telecentric optical system is constructed to converge the rays of light emitted from all the through-holes of the honeycomb structure, so that the inspection images are formed corresponding to all the through-holes of the honeycomb structure.

3. A piercing inspection apparatus according to claim 1, wherein said honeycomb structure is made of a ceramic or a metal.

4. A piercing inspection apparatus according to claim 1, further comprising an axis alignment means for aligning the optical axis of the telecentric optical system with the direction of the axes of the through-holes of the honeycomb structure.

5. A piercing inspection apparatus to inspect piercing of through-holes of a honeycomb structure having a number of parallel through-holes which extend therethrough from a first open end to a second open end of the honeycomb structure, comprising;
a lighting device which emits light onto the first open end of the honeycomb structure, so that the light passes through the through-holes;
an optical system which converges the light emitted from the through-holes at the second open end to form inspection images corresponding to the through-holes;
a camera which picks up the inspection images; and,
a monitor in which the picked up inspection images are indicated,
said optical system being provided with a Fresnel convex lens and a wide-angle lens, said Fresnel convex lens and said wide-angle lens being arranged with the optical axis and the focal point of the Fresnel convex lens being identical to those of the wide-angle lens.

6. A piercing inspection apparatus according to claim 5, wherein said optical system is constructed to converge the rays of light emitted from all the through-holes of the honeycomb structure, so that the inspection images are formed corresponding to all the through-holes of the honeycomb structure.

7. A piercing inspection apparatus according to claim 5, wherein said honeycomb structure is made of a ceramic or a metal.

8. A piercing inspection apparatus according to claim 5, further comprising an axis alignment means for aligning the optical axis of the optical system with the direction of the axes of the through-holes of the honeycomb structure.
